(19) United States
(12) Patent Application Publication
(10) Pub. No.: US 2019/0340503 A1
(43) Pub. Date: Nov. 7, 2019

(54) SEARCH SYSTEM FOR PROVIDING FREE-TEXT PROBLEM-SOLUTION SEARCHING

(71) Applicant: eBay Inc., San Jose, CA (US)

(72) Inventors: Han Cheng, San Francisco, CA (US); Manojkumar Rangasamy Kannadasan, Fremont, CA (US); Wenwan Yang, San Jose, CA (US); Yanjun Zhou, San Jose, CA (US)

(21) Appl. No.: 15/973,072

(22) Filed: May 7, 2018

(51) Int. Cl. G06N 3/08; G06F 17/30; G06Q 30/06

(52) U.S. Cl. CPC G06N 3/08; G06Q 30/0625; G06F 17/30867

(57) ABSTRACT

Various methods and systems for providing query result titles using a problem-solution search engine in a search system are provided. A query is received; the query is identified as a free-text query. Problem description features are identified from the free-text query. The problem description features characterize an issue described in the free-text query. Solution description features associated with product titles are accessed, where solution description features characterize a resolved issue described in a product review. A product associated with the product review is the product that resolved the resolved issue in the product review. The problem description features are compared to the solution description features. A product title is identified as a query result title. The product title is selected based on solution description features of the product title corresponding to the problem description features of the free-text query. The query result title is communicated.

### BACKGROUND

Users often rely on search systems to help find information stored on computer systems. Such search systems support identifying, for received search queries, search query result items from item databases. For example, a search query, having one or more keywords, can be executed using a search system to find relevant search result items based on the one or more keywords of the search query. With the ever-increasing use of search systems for retrieving electronically stored information, improvements in computing operations for search systems can provide more efficient processing of search queries and efficiency in user navigation of graphical user interfaces in search systems.

### SUMMARY

Embodiments of the present invention relate to methods, systems and computer storage media for providing a search system having free-text query processing functionality for providing query result titles. By way of background, performing keyword searches can be challenging for users because conventional search systems provide search query result items based primarily on the keywords or terms in the search query. For example, “car scratch repair” would yield results that match keywords “car”, “scratch”, and “repair”. Users sometimes do not know the right keywords to use as part of a search query to perform a search. When a user lacks the descriptive keywords or terms to define a search query, the search system may provide poor search result items that do not reflect the intent of the user for performing the search. Moreover, the user has to navigate and click-through several different user interfaces for every new attempted search query. In this regard, performing a search can often include several manual actions of trial and error keywords or keyword suggestions and corresponding review of search result items interfaces to potentially identify the appropriate keywords that yield the search query results items that align with the user's search intent. As such, an alternative approach for providing searching functionality in search systems would improve computing operations and user interface navigation in search systems.

Embodiments described in the present disclosure are directed towards improving search systems based on free-text query functionality. In particular, free-text problem-solution searching is provided based on a problem-solution model (i.e., a machine-learning model) that supports data mining for solution description features and problem description features. For example, a resolved issue in a product review for a product, or a described resolvable issue in a product description of a product, may be characterized as solution description features. The problem-solution data mining operations may analyze product reviews and product descriptions to determine solution description features associated with corresponding problems that are solved or problems that could be solved by the product. Also, a problem described as a free-text query may be characterized as problem description features. As such, a product title may be identified for a free-text query when the solution description features of a product having the product title correspond to the problem description features of the free-text query. In some embodiments, novel user interfaces are generated and provided to support user interface navigation in performing searches based on free-text problem-solution searching.

In operation, a query is received; the query is identified as a free-text query. Problem description features are identified from the free-text query. The problem description features characterize an issue described in the free-text query. The solution description features associated with product titles are accessed, where solution description features characterize a resolved issue described in a product review. A product associated with the product review is the product that resolved the resolved issue in the product review. The problem description features are compared to the solution description features. A product title is identified as a query result title. The product title is selected based on solution description features of the product title corresponding to the problem description features of the free-text query. The query result title is communicated.

As such, the embodiments described herein improve computing operations for performing searches in a search system. In particular, the improvement to computing operations, based on problem-solution data mining operations and the problem-solution model, result in computing efficiency in search queries and efficiency in user navigation of graphical user interfaces of search systems.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary search system with a problem-solution search engine, in which embodiments described herein may be employed;

FIGS. 2A-2B are illustrations of exemplary search system interfaces for a problem-solution search engine, in which embodiments described herein may be employed;

FIGS. 3A-3B are illustrations of exemplary search system interfaces for a problem-solution search engine, in which embodiments described herein may be employed;

FIGS. 4A-4B are illustrations of exemplary search system interfaces for a problem-solution search engine, in which embodiments described herein may be employed;

FIG. 5 is a flow diagram showing an exemplary method for implementing a search system with a problem-solution search engine, in accordance with embodiments described herein;

FIG. 6 is a flow diagram showing an exemplary method for implementing a search system with a problem-solution search engine, in accordance with embodiments described herein;

FIG. 7 is a flow diagram showing an exemplary method for implementing a search system with a problem-solution search engine, in accordance with embodiments described herein; and

FIG. 8 is a block diagram of an exemplary computing environment suitable for use in implementing embodiments described herein.

### DETAILED DESCRIPTION

Search systems support identifying, for received queries, query result items from item databases. Item databases can specifically be for content platforms or item listing platforms such as EBAY content platform, developed by EBAY INC., of San Jose, Calif. A search query, having one or more keywords, can be executed using a search system to find relevant search results based on the one or more keywords of the search query. For example, “car scratch repair” would yield results that match keywords “car”, “scratch”, and “repair”. Such a keyword-based search system is ideal when a user knows the correct keywords to use as part of their search query, but the keyword-based search system framework fails in other contexts.

In conventional search systems, that operate based on keywords when executing searches, users may often not know the right keywords to use as part of a search query to perform a search. With regard to the “car scratch repair”, a better set of keywords might have been “car polishing compound” or “car wax”. When a user lacks the descriptive keywords or terms to define a search query, a search system may provide poor search results that do not reflect the intent of the user for performing the search. For example, for the following search query: “birthday gift for my kid”, a search engine can return a set of search results (e.g., items from an item listing database) that contain keywords (e.g., in the item titles or descriptions) that match the keywords in the search query. Other relevant search results (e.g., trending toys and games) can be overlooked with this methodology. Moreover, the user has to navigate and click through several different user interfaces for every new attempted search query. In this regard, performing a search can often include several manual actions of trial and error keywords or keyword suggestions and corresponding review of search results items to identify the appropriate keywords that yield the search query results items that align with the user's search intent. As such, a comprehensive search system with an alternative basis for identifying query result items can improve computing operations and user interface navigation in search systems.

Embodiments of the present invention are directed to simple and efficient methods, systems and computer storage media for improving search systems based on free-text problem-solution searching. In particular, the search system includes a problem-solution model, (i.e., a machine-learning model) that supports free-text problem-solution searching. Free-text problem-solution searching improves the search efficiency in a search system in that the search system may receive free-text format queries and then may generate search result items that are not exclusively determined based on keyword matching. Free-text problem-solution searching is provided based on the problem-solution model that supports data mining for solution description features and problem description features. For example, a resolved issue in a product review for a product, or a described resolvable issue in a product description of a product, may be characterized as solution description features. The problem-solution data mining operations may analyze product reviews and product descriptions to determine solution description features associated with corresponding problems that are solved or problems that could be solved by the product. Also, a problem described as a free-text query may be characterized as problem description features. As such, a product title may be identified for a free-text query when the solution description features of a product having the product title correspond to the problem description features of the free-text query. In some embodiments, novel user interfaces are generated and provided to support user interface navigation in performing searches based on free-text problem-solution searching.

In operation, a search system may implement several components to perform operations associated with providing query result titles for a free-text query. The components may perform specific operations based on information supported using the search system. A search engine in the search system may receive a query. The search engine may support different types of user interfaces for receiving the query. In particular, the user interface may be configured to support determining whether the query is processed as a keyword search query or a free-text query. For example, the search engine may support a free-text input indicator or interface feature that may be implemented as part of a user interface for receiving the query.

The free-text input indicator can be configured as a dedicated input indicator or a combined input indicator. With a dedicated input indicator the query is determined as a free-text query. The free-text input indicator may be a dedicated input indicator that supports explicitly retrieving the query as a free-text query. In other words, the query received is automatically processed as a free-text query. For example, a user interface may indicate where to enter a free-text query and where to enter a keyword search query. In another example, a voice-input interface may receive a query and the query is automatically processed as a free-text query. In the alternative, the free-text input indicator may be a combined input indicator that supports implicitly retrieving the query as a free-text query. In other words, the query is received and a determination is made whether the query is a free-text query or a keyword query before processing the query. Several different rules may be implemented for processing the query as a keyword query or a free-text query. For example, the number of words entered may be programmatically defined as a rule for identifying the query as a keyword query or a free-text query. Other attributes of the user interface or the user input may be programmed as rules for detecting free-text queries. As such, other variations and combinations of user interfaces and user interface operations for receiving and identifying free-text queries, for processing, are contemplated with embodiments of the present invention.

Further, in operation, solution description features that are associated with a product title are accessed. By way of background, the search engine can be part of a product listing platform that supports access to a product database. The products in the product database may be stored based on a data structure having a structural arrangement of products (e.g., a product category and a product classification system). For example, a product database may be implemented with a database schema that stores product listings based on product titles. Products in the product database can further include product descriptions and product reviews. Product descriptions and product reviews may include a problem description, a solution description, and a product description, as discussed in more detail below.

As an initial matter, products, and by extension product titles, may be associated with product descriptions and product reviews. Product descriptions describe elements or aspects of a product. For example, a product description may include a description of the benefits of using the product. In this regard, the product description may include text that describes a resolvable issue that corresponds to a product. For example, a car wax compound product description may include a description indicating that having a dent on your car be repaired using the car wax product. In addition, product reviews of products in a product listing platform may describe a problem, a solution and a corresponding product. For example, after using a car wax compound, a user or product reviewer may self-report on the car wax compound and provide insights of the problem they faced and how the car wax compound resolved the problem. The product descriptions and product reviews, each alone or in combination, may be used to define solution description features that are used in identifying query result titles. In particular, the product descriptions and product reviews are analyzed to extract solution description features. The solution description features may be programmatically defined and organized to be retrieved as discussed herein in more detail. In one example, the solution description features are stored to correspond to a problem description, a solution description, or a product description.

The problem-solution search engine may implement a problem-solution model that supports making predictions on, or identifying of, problem description features from the free-text query based on solution description features that are extracted from product reviews and product descriptions. The problem-solution search engine may support text classification as part of natural language processing of the product descriptions and product reviews. At a high level, the problem-solution search engine may include a problem-solution model (i.e., a machine-learning model) that implements one or more machine learning classifiers. The machine-learning model is trained based on product reviews and product descriptions of a product listing platform, where training is based on Convolutional Neural Network and Bidirectional Long Short-Term Memory encoding. In particular, text may be analyzed at a character level using convolution network techniques. Convolution neural networks support deep learning without artificially embedding knowledge about words, phrases, sentences, or any other syntactic or semantic structures associated with language. Bi-directional long short-term memory (Bi-LSTM) is an artificial neural network where connections between units form a directed graph along a sequence. In particular, Bi-LSTM may be used for processing sequential data. The problem-solution engine implements both a convolutional neural network and Bi-LSTM for encoding and classifying product description text and product review text. For example, the convolution neural network may be used to encode sentences into characters and the characters are processed using a Bi-LSTM to build a model of contextual information. By way of example, the product reviews and products descriptions are processed using data mining operations that include filtering out unimportant sentences and selecting important sentences for additional processing. The problem-solution machine learning model may specifically identify important sentences as sentences that are relevant to a problem description, a solution description, or a product description. Important sentences may be programmatically defined as features.

Overall, the data mining operations support identifying features from product descriptions and product reviews and also from free-text queries. Data mining identifies patterns, situations, connections and context around problem descriptions, solutions descriptions and product descriptions. In this regard, a feature of the solution description features or the problem description features is a relevant characteristic corresponding to a problem description, a solution description, or a product description. Feature extraction may be performed using any number of algorithms (e.g., matrix factorization, pattern intersection). Feature extraction may initially start with the product reviews, product description, and the build derived values intended to be informative and non-redundant, facilitating the subsequent learning and generalization characteristics. By way of example, a feature may be an explicit rating or an implicit rating that is determined from a product review. A user may provide a quantified rating of a product (e.g., number of stars) and product review for a product may include positive remarks or sentences that reflect a positive review for the product.

Advantageously, in order to find the most relevant product titles, identifying solution description features may be based on first identifying product reviews having a threshold minimum rating that indicate an extent that a product described in a solution (e.g., product review) actually resolved the corresponding issue or problem. In this regard, the solution description features would more accurately reflect products that resolve a corresponding problem or relevant to a free-text query. It is contemplated that other features may be prioritized during data mining operations for achieving specific goals in generating the solution description features. In one embodiment, the set of solution description features may be mapped to a product or a product category and a product classification. As such, features may be assigned to elements of an ontology system or other classification categories.

The free-text received as a free-text query may be analyzed using the problem-solution model developed in part based on analyzing product reviews or product descriptions, to generate the problem description features. The machine learning model training supports analyzing the free-text query to make predictions or identify problem description features and product titles. Identifying product titles is based on comparing the problem description features to solution description features. The comparison logic for identifying feature similarity may include fuzzy logic, neural network, finite state machine, support vector machine, logistic regression, clustering, or machine-learning techniques, similar statistical classification processes, or combinations of these to identify and compare corresponding features to determine similarity via the problem-solution model.

Using the problem-solution model, predictions may be made about problem description features of free-text queries and by extension predictions may be made about product titles that correspond to the free-text query. For example, a free-text query (e.g., “lipstick for night out”) may be received and analyzed to identify problem description features (e.g., “lipstick”, “cosmetic product” “night out”, “event”), in particular, the problem descriptions are based on the features defined from training the machine-learning model. The problem description features are compared to solution description features to identify a product having product review with most similar features. For example, a REVLON Ultra-longwear lipstick may be selected as a product title where the product review recited “Great lipstick color and long-lasting. Apply once and great for a night out on the town.” REVLON Ultra-longwear lipstick is selected because the problem description features (i.e., “lipstick”, “cosmetic product” “night out”, “event”) are most similar (e.g., based on a similarity score from a comparison logic) to the solution description features identified in the product review. In some embodiments, a product category and product classification that are determined based on comparing the problem description features to the solution description features are also identified and provided via a user interface or leveraged additional search engine functionality (e.g., ranking, query suggestions, query result item interfaces) associated with the search engine.

Embodiments of the present invention have been described with reference to several inventive features (e.g., operations, systems, engines, and components) associated with a search system having the problem-solution model. Inventive features described include: operations for modeling solution description features and problem description features that are compared for identifying product titles that correspond to a free-text query having the problem description features. Functionality of the embodiments of the present invention have further been described, by way of an implementation and anecdotal examples, to demonstrate that the operations for providing query result items using an problem-solution search engine are an unconventional ordered combination of operations that operate with a problem-solution search engine as a solution to a specific problem in search technology environment to improve computing operations and user interface navigation in search systems. Overall, these improvements result in less CPU computation, smaller memory requirements, and increased flexibility in search systems.

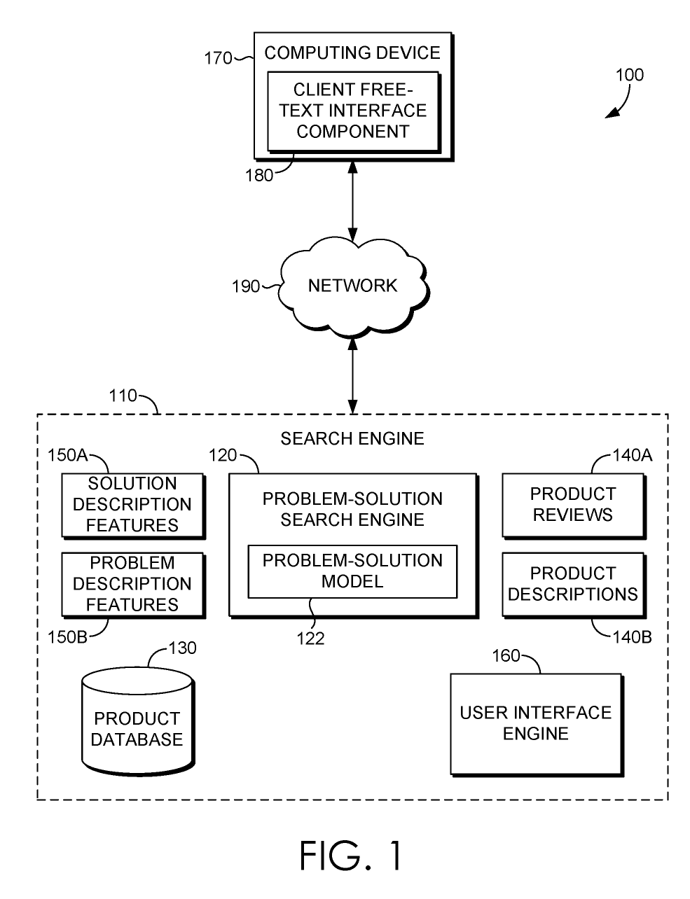

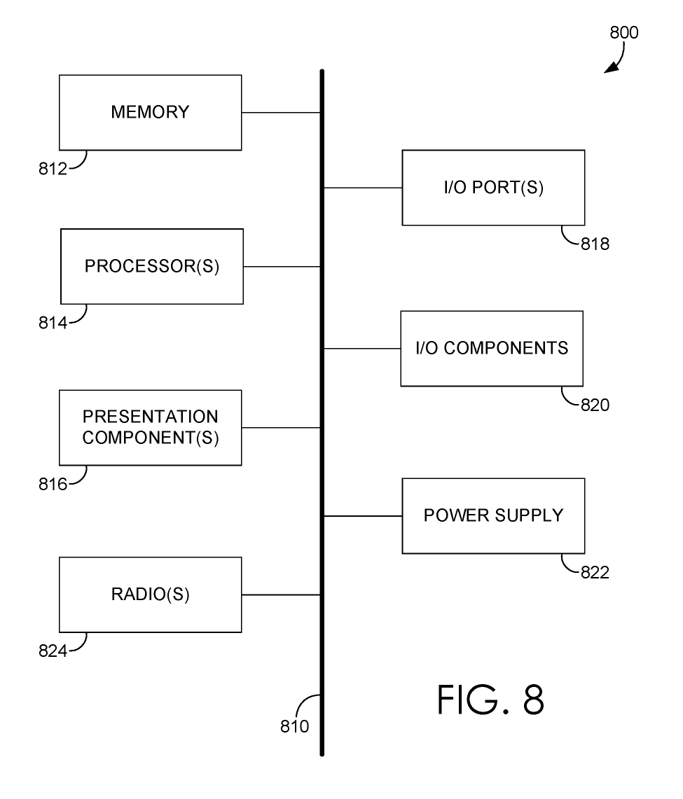

With reference to FIG. 1, FIG. 1 illustrates an exemplary search system 100 in which implementations of the present disclosure may be employed. In particular, FIG. 1 shows a high level architecture of search system 100 having components in accordance with implementations of the present disclosure. Among other components, managers, or engines not shown, search system 100 includes a computing device 170 having a client free-text interface component 180. The computing device 170 communicates via a network 190 with a search engine 110. The search engine 110 includes problem-solution search engine 120 having a problem solution model 122, product database 130, product reviews 140A, product descriptions 140B, solution description features 150A and problem description features 140B, and user interface engine 160 and product database 130. The components of the search system 100 may communicate with each other over one or more networks (e.g., public network or virtual private network “VPN”) as shown with network 190. The network 190 may include, without limitation, one or more local area networks (LANs) and/or wide area networks (WANs). The computing device 170 may be a client computing device that corresponds to the computing device described herein with reference to FIG. 8.

The components of the search system 100 may operate together to provide functionality for generating query result items based on a problem-solution search engine, as described herein. The search system 100 supports processing queries from the computing device 170. In particular, the computing device 170 may receive a query (e.g., a query from a user using a product listing platform) and communicate the query to the search engine 110. The computing device 170 may also receive query result titles (i.e., results data) for the query from the search engine 110 and display or cause display of the query result titles. The search engine 110 is responsible for identifying result titles for queries received at the search engine 110. Results data including result titles may generally refer to a representation, identifier, or additional related data and metadata associated with a product listing in a product database, where a result title is identified as being responsive to a corresponding query. The search engine 110 may receive a query such that result titles for the query are provided, generated, identified, ranked or communicated based on and using the components in the search engine 110.

Search engine 110 is responsible for providing free-text problem-solution searching functionality for the product listing platform. Search engine 110 includes the components identified above for identifying query result titles based on the problem-solution search engine 120. Problem-solution search engine 120 manages operations for providing free-text query functionality. The problem solution search engine 120 includes a problem-solution model 122 that is a machine-learning model that is used to extract features from product reviews 140A and product descriptions 140B to generate solution description features 150A. For example, a resolved issue in a product review for a product, or a described resolvable issue in a product description of a product may be characterized as solution description features 150A.

The problem-solution search engine implements data mining operations that analyze product reviews and product descriptions to determine solution description features associated with corresponding problems that are solved or problems that could be solved by the product. Product reviews 140A and product descriptions 140B may be associated with products in the product database 130 that stores product listings using a data structure having a structural arrangement or products, such as product categories and product classifications. The problem-solution model 122 further extracts problem description features 150B from free-text queries. For example, a problem described as a free-text query may be characterized as problem description features.

The problem-solution search engine 120 is responsible for implementing the problem-solution model 122 to support making predictions on, or identifying of, problem description features 150B from free-text queries. The problem description features 150B are determined based in part on solution description features 150A that are extracted from product reviews and product descriptions. The problem-solution model 122 is a machine learning model that is trained based on product reviews 140A and product descriptions 140B. The problem description features 150B are compared to solution description features 150A to identify product titles that correspond to the problem description features 150B.

In embodiments, a user interface engine 160 is responsible for providing novel user interfaces that support user interactions with components of the search engine 110. For example, the user interface engine 160 may support different types of user interfaces for receiving the query. In particular, the user interface engine 160 may be configured to support determining whether the query is processed as a conventional keyword query or a free-text query. For example, the user interface engine may support a free-text input indicator feature that may be implemented as part of a user interface for receiving the query. With a free-text input indicator the query is determined as a free-text query.

In one embodiment, a client free-text interface 180 may operate with the user interface engine 160 to manage user interface operations at the computing device 170. For example, the free-text input indicator may be a dedicated input indicator that supports explicitly retrieving the query as a free-text query. In other words, the query received is automatically processed as a free-text query. For example, a user interface at the computing device 170 may indicate where to enter a free-text query and where to enter a keyword search query.

In another example, at the computing device 170, a voice-input interface may receive a query and the query is automatically processed as free-text query. In the alternative, the free-text input indicator may be a combined input indicator that indicates implicitly retrieving the free-text query. In other words, the query is received and a determination is made, at the client free-text interface component 180, or at the user interface engine 160, whether the query is a free-text query or a keyword query before processing the query. Several different rules may be implemented via the user interface engine 160 for processing the query as a keyword query or a free-text query. For example, the number of words entered may be codified as a rule for identifying the query as a keyword query or a free-text query.

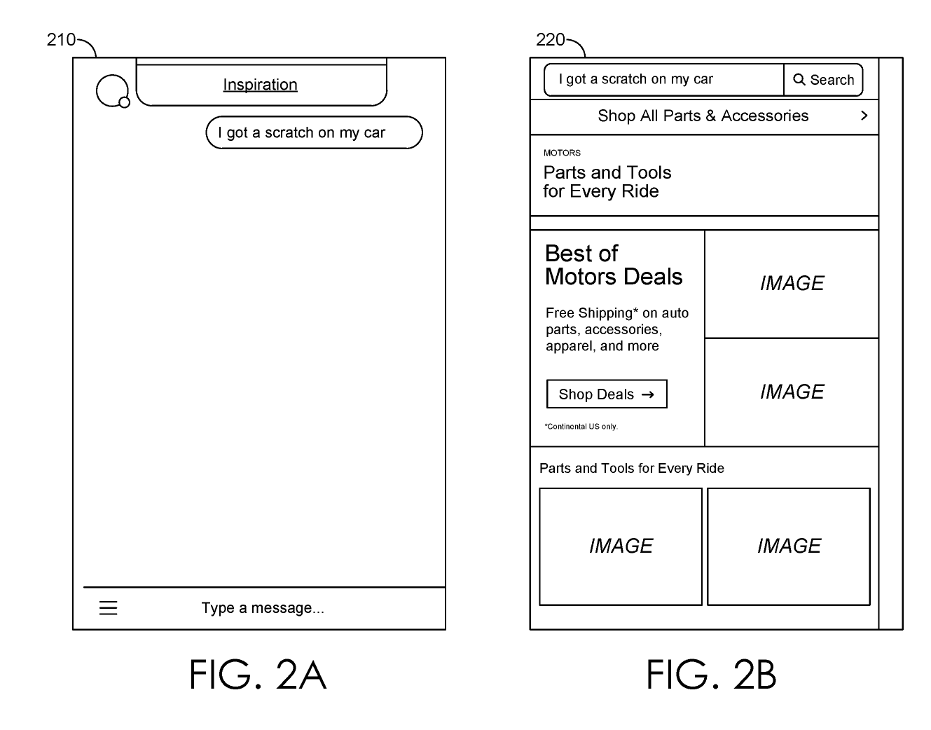

Embodiments of the present invention may further be described with reference to FIGS. 2A, 2B, 3A, 3B, 4A, and 4B that provide illustrations and operations of user interfaces associated with components of the search system 100. At a high level, the user interfaces support improving computer operations based on improving user navigation based on the free-text problem-solution searching. The free-text problem-solution searching allows for user interface interaction models (e.g., shopping assistant) that use the components of the search system to provide novel user interfaces as described in more detail below.

With reference to FIGS. 2A and 2B, FIGS. 2A and 2B illustrate example interfaces that are used for receiving free-text queries. The user interface 210 may be configured as a free-text query input interface (e.g., messaging interface or voice-input interface) such that a user may enter a free-text query and the free-text query is automatically processed, using techniques described herein, to generate query result items. In particular, upon entering the free-text query, the user interface 220 may be generated having the query result items. The query results items are generated based on free-text problem-solution searching and corresponding components.

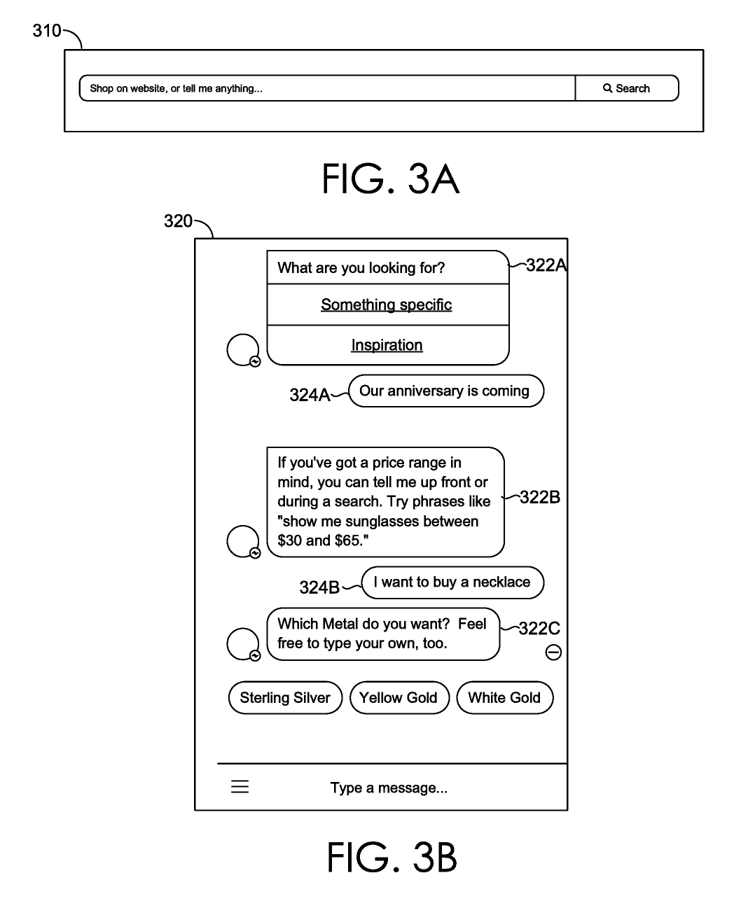

With reference to FIGS. 3A and 3B, FIGS. 3A and 3B illustrate additional example interfaces that are used for receiving free-text queries. As discussed, free-text queries may be received, and based on an association with a free-text input indicator, free-text queries may be implicitly or explicitly processed as free-text queries. For example, the search input bar 310 (e.g., from a web interface) may be configured to receive free-text queries, such that any queries entered in the search input bar 310 are automatically processed as free-text queries. In the alternative, the search input bar 310 may process a query as a free-text query or a keyword query upon determining whether the query is a free-text query or a keyword query, using different techniques described herein. For examples, a threshold number of keywords entered into the search bar, a user context when performing the search, a user input prior to performing the search, may all be variations of rules or elements for determining whether the search is processed as a free-text query.

With reference to FIG. 3B, the user interface (e.g., a messaging system interface or voice-input interface) may be configured to process free-text queries. The free-text queries may be determined through a series of prompts (e.g., 322A, 322B, and 322C) and responses (e.g., 324A and 324B). For example, an intelligent shopping assistant may be configured as part of a user interface engine to support processing free-text queries. In particular, each response may be processed as a free-text query and in addition or in the alternative, after a series of questions from the shopping assistant, the combination of responses may be defined as the free-text query and processed using the problem-solution search engine. As such, the problem-solution search engine supports a user interface interaction model that supports processing free-text queries via a shopping assistant or via a series of questions that are used to identify a free-text query from corresponding responses, for processing using techniques described herein.

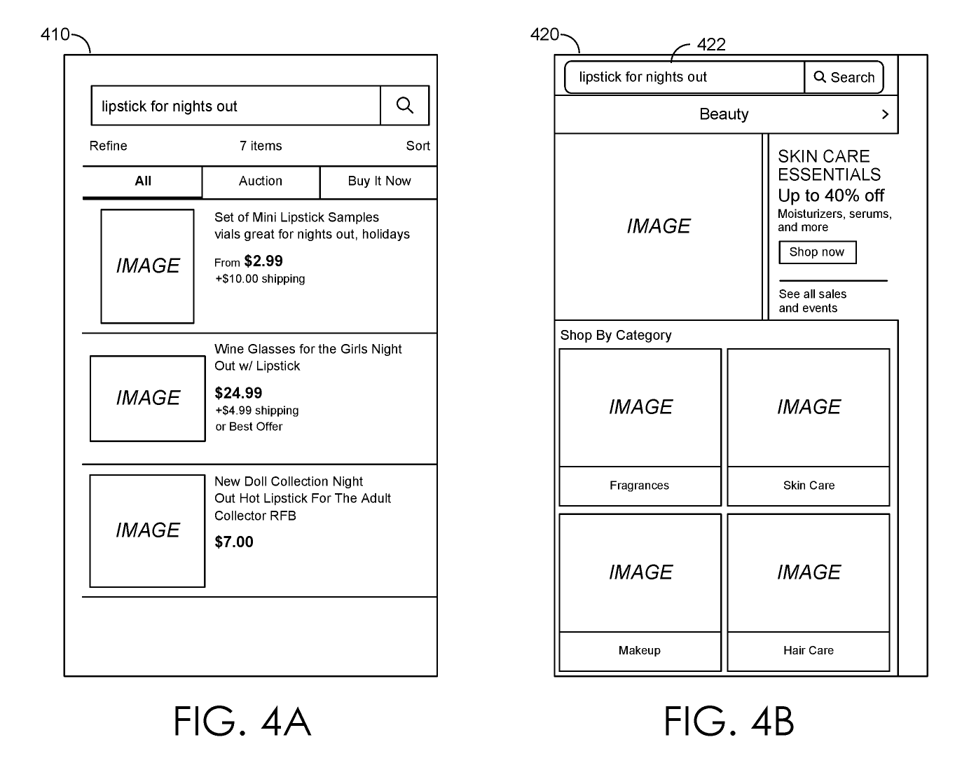

With reference to FIGS. 4A and 4B, FIGS. 4A and 4B illustrate that the search system may support simultaneously both a keyword query interaction interface and a free-text query interaction interface. For example, FIG. 4A illustrates query results interface 410 that is generated based on the search system executing a keyword query search and FIG. 4B illustrates a query results interface 420 that is generated based on the search system executing a free-text problem-solution search. The difference between query results interface 410 and query results interface 420 also illustrates the improvement provided via the free-text problem-solution searching in that query results interface 410 includes results data that is based on keyword searching in contrast to query results interface 420 that includes results data that is based on free-text problem-solution searching. In particular, the results data from the query results interface 420 is generated based on comparing problem description features of the free-text query “lipstick for night out” 422 to solution description features of the product listing platform. As such, the results data reflect an improved set of results data compared to basic keyword matching search techniques.

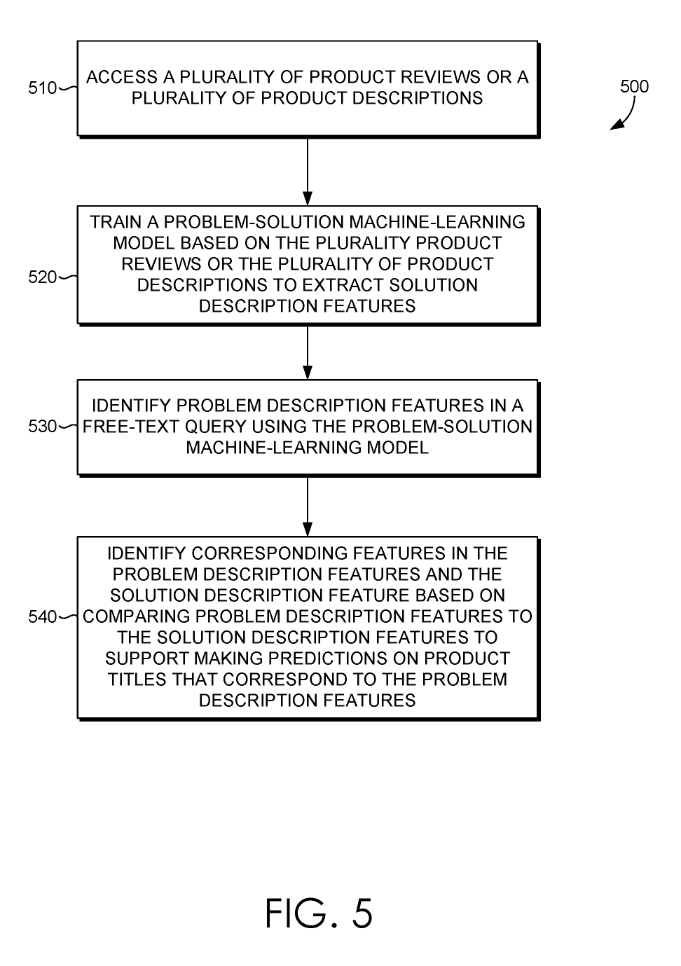

With reference to FIGS. 5, 6, and 7, flow diagrams are provided illustrating methods for implementing a search system for providing query result items using a problem-solution search engine. The methods may be performed using the search system described herein. In embodiments, one or more computer storage media having computer-executable instructions embodied thereon that, when executed, by one or more processors can cause the one or more processors to perform the methods in the search system.

Turning to FIG. 5, a flow diagram is provided that illustrates a method 500 for implementing a search system for providing query result items based on a problem-solution search engine. Initially at block 510, a plurality of product reviews or a plurality of product descriptions are accessed. At block 520, a problem-solution machine-learning model is trained based on the plurality of product reviews or the plurality of product descriptions to extract solution description features. At block 530, problem description features in a free-text query are identified using the problem solution machine-learning model. At block 540, features in the problem description features that correspond to features in the solution description are identified based on comparing problem description features to the solution description features to support making predictions on product titles that correspond to the problem description features.

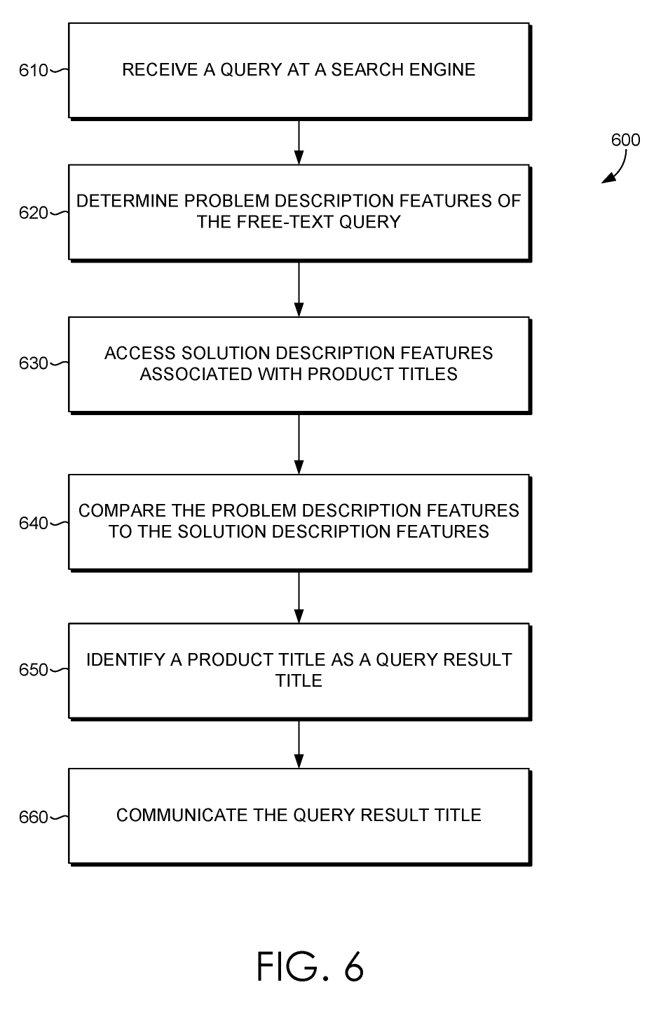

Turning to FIG. 6, a flow diagram is provided that illustrates a method 600 for implementing a search system for providing query result items based on a problem-solution search engine. Initially at block 610, a query is received at a search engine. At block, 620, problem description features of the free-text query are determined. At block 630, solution description features associated with product titles are accessed. At block 640, problem description features are compared to the solution description features. At block 650, a product title is identified as a query result title. At block 660, the query result title is communicated.

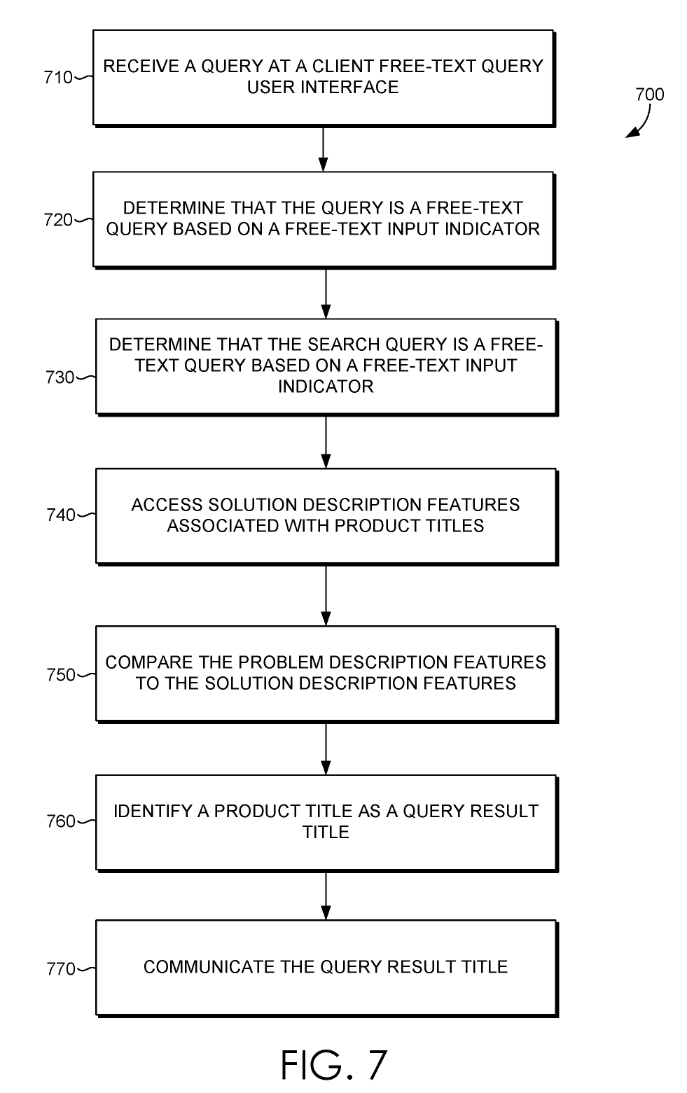

Turning to FIG. 7, a flow diagram is provided that illustrates a method 700 for implementing a search system for providing query result items based on a problem-solution search engine. Initially at block 710, a query is received at a client free-text query user interface of a client device. At block 720, it is determined that the query is a free-text query based on a free-text input indicator. At block 720, the free-text query is communicated to a search engine. At block 740, solution description features associated with product titles are accessed at the search engine. At block 750, the problem description features are compared to the solution description features. At block 760, a product title is identified as a query result title based on comparing the problem description features to the solution description features. At block 770, the query result title is communicated to the client device.

With reference to the search system 100, embodiments described herein support providing query result items based on a problem-solution search engine. The search system components refer to integrated components that implement the image search system. The integrated components refer to the hardware architecture and software framework that support functionality using the search system components. The hardware architecture refers to physical components and interrelationships thereof and the software framework refers to software providing functionality that may be implemented with hardware operated on a device. The end-to-end software-based search system may operate within the other components to operate computer hardware to provide search system functionality. As such, the search system components may manage resources and provide services for the search system functionality. Any other variations and combinations thereof are contemplated with embodiments of the present invention.

By way of example, the search system may include an API library that includes specifications for routines, data structures, object classes, and variables may support the interaction the hardware architecture of the device and the software framework of the search system. These APIs include configuration specifications for the search system such that the components therein may communicate with each other for form generation, as described herein.

With reference to FIG. 1, FIG. 1 illustrates an exemplary search system 100 in which implementations of the present disclosure may be employed. In particular, FIG. 1 shows a high level architecture of search system 100 having components in accordance with implementations of the present disclosure. It should be understood that this and other arrangements described herein are set forth only as examples. In addition, a system, as used herein, refers to any device, process, or service or combination thereof. As used herein, engine is synonymous with system unless otherwise stated. A system may be implemented using components or generators as hardware, software, firmware, a special-purpose device, or any combination thereof. A system may be integrated into a single device or it may be distributed over multiple devices. The various components or generators of a system may be co-located or distributed. For example, although discussed for clarity as the content application component, operations discussed may be performed in a distributed manner. The system may be formed from other systems and components thereof. It should be understood that this and other arrangements described herein are set forth only as examples.

Having identified various component of the search system 100, it is noted that any number of components may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Further, although some components of FIG. 1 are depicted as single components, the depictions are exemplary in nature and in number and are not to be construed as limiting for all implementations of the present disclosure. The search system 100 functionality may be further described based on the functionality and features of the above-listed components.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Having described an overview of embodiments of the present invention, an exemplary operating environment in which embodiments of the present invention may be implemented is described below in order to provide a general context for various aspects of the present invention. Referring initially to FIG. 8 in particular, an exemplary operating environment for implementing embodiments of the present invention is shown and designated generally as computing device 800. Computing device 800 is but one example of a suitable computing environment and is not intended to suggest any limitation as to the scope of use or functionality of the invention. Neither should the computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes a bus 810 that directly or indirectly couples the following devices: memory 812, one or more processors 814, one or more presentation components 816, input/output ports 818, input/output components 820, and an illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 8 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters” using communication media described herein. Also, the word “initiating” has the same broad meaning as the word “executing or “instructing” where the corresponding action can be performed to completion or interrupted based on an occurrence of another action. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the search system and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A computer-implemented for providing query result titles, the method comprising:
receiving a query at a search engine, wherein the query is identified as a free-text query;
determining problem description features of the free-text query, wherein the problem description features characterize an issue described in the free-text query;
accessing solution description features associated with product titles, wherein the solution description features characterize a resolved issue described in a product review, wherein a product associated with the product review resolves the issue;
comparing the problem description features to the solution description features;
identifying a product title as a query result title, wherein the product title is selected based on solution description features of the product title corresponding to the problem description features of the free-text query; and
communicating the query result title.

2. The method of claim 1, wherein identifying the query as the free-text query is based on a free-text input indicator, wherein the free-text input indicator is selected from one of the following: a dedicated input indicator that supports explicitly retrieving the query as the free-text query; or a combined input indicator that supports implicitly retrieving the query as the free-text query.

3. The method of claim 1, wherein comparing the problem description features to the solution description features is based on a problem-solution model that supports identifying problem description features from the free-text query based on solution description features that are extracted from product reviews and product descriptions, wherein a set of solution description features is mapped to a product or a product category and a product classification.

4. The method of claim 3, wherein the product-solution model is trained based on product reviews and product descriptions of a product listing platform, wherein training comprises Convolutional Neural Network and Bidirectional Long Short-Term Memory encoding.

5. The method of claim 1, wherein a feature of the solution description features or the problem description features is a relevant characteristic corresponding to a problem description, a solution description, or a product description.

6. The method of claim 1, wherein the solution description features are derived from product reviews having a threshold minimum rating that indicates an extent that a product in a solution description resolved a corresponding issue.

7. The method of claim 1, further comprising determining a product category and a product classification based on comparing the problem description features to the solution description features, wherein the problem-solution model is trained based on product categories and product classifications of a product listing platform.

8. One or more computer storage media having computer-executable instructions embodied thereon that, when executed, by one or more processors, cause the one or more processors to perform a method for providing query result titles, the method comprising:
receiving a query at a search engine, wherein the query is identified as a free-text query;
determining problem description features of the free-text query, wherein the problem description features characterize an issue described in the free-text query;
accessing solution description features associated with product titles, wherein the solution description features characterize a resolved issue described in a product review, wherein a product associated with the product review resolves the issue;
comparing the problem description features to the solution description features, wherein comparing the problem description features to the solution description features is based on a problem-solution model supports making predictions of problem description features from the free-text query based on solution description features;
identifying a product title as a query result title, wherein the product title is selected based on solution description features of the product title corresponding to the problem description features of the free-text query; and
communicating the query result title.

9. The media of claim 8, wherein identifying the query as the free-text query is based on a free-text input indicator, wherein the free-text input indicator is selected from one of the following: a dedicated input indicator that supports explicitly retrieving the query as the free-text query; or a combined input indicator that supports implicitly retrieving the query as the free-text query.

10. The media of claim 8, wherein the solution description features are extracted from product reviews and product descriptions, wherein a set of solution description features is mapped to a product or a product category and a product classification.

11. The media of claim 9, wherein the product-solution model is trained based on product reviews and product descriptions of a product listing platform, wherein training comprises Convolutional Neural Network and Bidirectional Long Short-Term Memory encoding.

12. The media of claim 8, wherein a feature of the solution description features or the problem description features is a relevant characteristic corresponding to a problem description, a solution description, or a product description.

13. The media of claim 8, wherein the solution description features are derived from product reviews having a threshold minimum rating that indicates an extent that a product in a solution description resolved a corresponding issue.

14. The media of claim 8, further comprising determining a product category and a product classification based on comparing the problem description features to the solution description features, wherein the problem-solution model is trained based on product categories and product classifications of a product listing platform.

15. A search system for providing query result items, the system comprising:
one or more processors; and
one or more computer storage media storing computer-useable instructions that, when used by the one or more processors, cause the one or more processors to execute:
a client user interface component:
receive a query;
determine that the search query is a free-text query based on a free-text input indicator; and
communicate the free-text query; and
a problem-solution search engine:
receive the free-text query;
determine problem description features of the free-text query, wherein the problem description features characterize an issue described in the free-text query;
access solution description features associated with product titles, wherein the solution description features characterize a resolved issue described in a product review, wherein a product associated with the product review resolves the issue;
compare the problem description features to the solution description features;
identify a product title as a query result title, wherein the product title is selected based on solution description features of the product title corresponding to the problem description features of the free-text query; and
communicate the query result title.

16. The system of claim 15, wherein identifying the query as the free-text query is based on a free-text input indicator, wherein the free-text input indicator is selected from one of the following: a dedicated input indicator that supports explicitly retrieving the query as the free-text query; or a combined input indicator that supports implicitly retrieving the query as the free-text query.

17. The system of claim 15, wherein comparing the problem description features to the solution description features is based on a problem-solution model that supports identifying problem description features from the free-text query based on solution description features that are extracted from product reviews and product descriptions, wherein a set of solution description features is mapped to a product or a product category and a product classification.

18. The system of claim 15, wherein a feature of the solution description features or the problem description features is a relevant characteristic corresponding to a problem description, a solution description, or a product description.

19. The system of claim 15, wherein the solution description features are derived from product reviews having a threshold minimum rating that indicates an extent that a product in a solution description resolved a corresponding issue.

20. The system of claim 15, further comprising determining a product category and a product classification based on comparing the problem description features to the solution description features, wherein the problem-solution model is trained based on product categories and product classifications of a product listing platform.
